(19) United States
(12) Patent Application Publication
(10) Pub. No.: US 2012/0193569 A1
(43) Pub. Date: Aug. 2, 2012

(54) DEICER COMPOSITION

(75) Inventor: Robert Scott Koefod, Maple Grove, MN (US)

(73) Assignee: CARGILL, INCORPORATED, Wayzata, MN (US)

(21) Appl. No.: 13/499,811

(22) PCT Filed: Oct. 5, 2010
(86) PCT No.: PCT/US10/51486

§ 371 Date: Apr. 2, 2012

Related U.S. Application Data
(60) Provisional application No. 61/248,687, filed on Oct. 5, 2009.

(51) Int. Cl. C09K 3/18

(52) U.S. Cl. 252/70

(57) ABSTRACT

The present disclosure relates generally to deicer compositions comprising a liquid deicing agent which is as an aqueous solution of a deicing salt and an additive that provides reduced corrosiveness and increased residual effect. Aspects of the disclosure are particularly directed to use of the deicer composition as a liquid deicer or an anti-icer. The deicer composition can further include a solid deicing agent such as sodium chloride, where the liquid deicing agent and additive form a pre-wetting agent when mixed with the solid deicing agent to form a pre-wetted deicer.

### CROSS REFERENCE TO RELATED APPLICATION

This application claims the benefit of U.S. Provisional Application No. 61/248,687 filed 5 Oct. 2009 entitled DEICER COMPOSITION, which is hereby incorporated by reference.

### FIELD

The present application relates generally to deicer compositions comprising a liquid deicing agent and an additive that provides reduced corrosiveness. Aspects of the disclosure are particularly directed to use of the composition as a liquid deicer, an anti-icer, or pre-wetting agent.

### BACKGROUND

This application relates to deicer compositions. More particularly, the application relates to deicer compositions with reduced corrosiveness that can be used as a liquid deicer, a pre-wetting agent when mixed with a deicing salt to form a pre-wetted deicer, or an anti-icer.

Deicer compositions can include a liquid deicing agent such as aqueous solutions of chloride, acetate or formate salts such as sodium chloride, magnesium chloride, calcium chloride, potassium chloride, urea, potassium acetate, calcium magnesium acetate, sodium formate, potassium formate, or combinations thereof; such compositions are commonly used in winter road maintenance. Deicer compositions are routinely used as anti-icers when they are applied directly to a surface prior to a snow storm. They serve to melt the boundary layer of snow between the surface and the accumulated snow pack, thereby preventing the snow from bonding to the surface and facilitating its removal by snow plows. The deicer composition can also be used as a deicer to melt snow or ice that has accumulated on a surface.

Deicer compositions (or deicers) can further include a solid deicing salt, such as sodium chloride, where the liquid deicing agent and additive are pre-wetting agents that can be added to the solid deicing salt. Solid deicing salts that are treated with a pre-wetting agent are often referred to in the industry as “treated salts” or “pre-wetted deicers”. Additives to the deicer composition can include compounds that act as corrosion inhibitors or provide other benefits. Pre-wetting a solid deicer salt with a liquid deicing agent and an additive such as a corrosion inhibitor can provide a number of performance advantages, including reduction of corrosion to equipment, helping the solid deicing salt adhere to the road surface, thereby reducing the loss of salt due to bounce and scatter from the road, and improving the flowability and freeze resistance of the treated salt. The liquid deicing agent and additive can be sprayed onto the solid deicing salt at the moment it is applied onto the road, although this requires special equipment. Thus, it is often desirable to pre-blend the liquid deicing agent and additive with the solid deicing salt so that the pre-wetted deicer can be applied using the same standard equipment and trucks used to apply solid deicing salt to roads. Another method of mixing the liquid deicing agent and additives to the solid deicing salt to form a treated salt is disclosed in U.S. Pat. No. 7,100,760 entitled “Deicer Mixing Apparatus and Method” to Cargill, Incorporated.

Deicer performance is typically characterized by the composition's “ice melting capacity” at different temperatures. This is determined by the industry standard methods SHRP H205.1 and H205.2 for solid and liquid deicer compositions, respectively. The test involves application of a given amount of deicer to a tray of ice in a controlled temperature chamber, after which the volume of ice melted is measured at various time intervals.

Further work on these deicer compositions has revealed that these additives surprisingly in combination with the liquid deicing agent form a deicer combination which provides unanticipated benefits of corrosion inhibition.

### SUMMARY

The present disclosure relates to a deicer composition comprising a liquid deicing agent and an additive to inhibit corrosion. The deicer composition can include a liquid deicing agent such as an aqueous solution of a deicing salt such as a chloride, acetate or formate salt and an additive such as hydroxyethyl cellulose. The deicer composition can additionally include a solid deicing agent. Other performance enhancers can be added to the deicer composition, such as other corrosion inhibitors, radiation absorbers, or leaching inhibitors.

One embodiment is directed toward a deicer composition comprising a liquid deicing agent and an additive. The liquid deicing agent can comprise an aqueous solution of a deicing salt. The deicing salt of the liquid deicing agent can be a chloride, acetate or formate salt. Deicing salts can include sodium chloride, magnesium chloride, calcium chloride, potassium chloride, urea, potassium acetate, calcium magnesium acetate, sodium formate, potassium formate, or combinations of these salts. The liquid deicing agent can also be comprised of liquid bittern, which is a product derived from sea salt production, and is the liquid remaining after sodium chloride is removed from the sea water.

The additive of the deicer composition can be selected from a variety of compounds, including but not limited to cellulose gum, polyvinyl pyrrolidone, acrylic acid polymers, cross linked acrylic polymers, polyether polyols, sodium carboxymethyl cellulose, hydroxyethyl cellulose, polyethylene oxides, polyethylene glycol, carboxymethyl hydroxypropyl guar, hydroxypropyl guar, polyanionic cellulose, pregelatinized crosslinked starch such as hydroxypropyl distarch phosphate and distarch phosphate, scleroglucan, pectin or combinations thereof In one embodiment, the additive is hydroxyethyl cellulose.

The deicer composition can further comprise a solid deicing agent, such as sodium chloride, magnesium chloride, calcium chloride, potassium chloride, urea, potassium acetate, calcium magnesium acetate, sodium formate, potassium formate, or combinations thereof In this embodiment, the liquid deicing agent and additive form a pre-wetting agent that is mixed with the solid deicing agent to form a pre-wetted decier. The most common solid deicing agent is sodium chloride, which is often mined as rock salt. Other performance enhancers can be added to the deicer composition, such as other corrosion inhibitors, radiation absorbers, or leaching inhibitors.

In another embodiment, a deicer composition comprises a liquid deicing agent and hydroxyethyl cellulose. The liquid deicing agent comprises an aqueous solution of a deicing salt. The deicing salt of the liquid deicing agent can be a chloride, acetate or formate salt such as sodium chloride, magnesium chloride, calcium chloride, potassium chloride, urea, potassium acetate, calcium magnesium acetate, sodium formate, potassium formate, or combinations thereof The most common solid deicing agent is sodium chloride, such as rock salt. The liquid deicing agent can also be comprised of liquid bittern. The deicer composition can further comprise a solid deicing agent, such as sodium chloride, magnesium chloride, calcium chloride, potassium chloride, urea, potassium acetate, calcium magnesium acetate, sodium formate, potassium formate, or combinations of thereof In this embodiment, the liquid deicing agent and the hydroxyethyl cellulose form a pre-wetting agent that is mixed with the solid deicing agent to form a pre-wetted deicer. Other performance enhancers can be added to the deicer composition, such as other corrosion inhibitors, radiation absorbers, or leaching inhibitors.

### DETAILED DESCRIPTION

Selected Definitions

As used herein, the following terms shall have the following meanings:

The term “deicer composition” as used herein is a combination of compounds used to melt snow or ice, or prevent snow or ice from bonding to a surface.

The term “liquid deicing agent” as used herein is an aqueous solution of a deicing salt. A liquid deicing agent can be a mixture of water and a deicing salt. It can also be a liquid bittern, which is a naturally-occurring mixture of magnesium chloride, sea water, and other compounds. The liquid deicing agent can be used as a deicer, an anti-icer, or it can be mixed with a solid deicing agent as a pre-wetting agent.

The term “additive” as used herein is a compound that is added to or mixed with a liquid deicing agent to form a deicer composition. Suitable additives include cellulose gum, polyvinyl pyrrolidone, acrylic acid polymers, cross linked acrylic polymers, polyether polyols, sodium carboxymethyl cellulose, hydroxyethyl cellulose, polyethylene oxide, polyethylene glycol, carboxymethyl hydroxypropyl guar, hydroxypropyl guar, polyanionic cellulose, pregelatinized crosslinked starch such as hydroxypropyl distarch phosphate and distarch phosphate, scleroglucan, pectin and combinations thereof.

The term “deicing salt” as used herein is a salt such as chloride, acetate or formate salt or urea, which can be mixed with water to form an aqueous solution referred to as a liquid deicing agent. The deicing salt of the liquid deicing agent can be a salt such as sodium chloride, magnesium chloride, calcium chloride, potassium chloride, urea, potassium acetate, calcium magnesium acetate, sodium formate, potassium formate, or combinations of these salts.

The term “solid deicing agent” as used herein is a salt preferably in solid form such as a chloride, acetate or formate salt. The solid deicing agent can be sodium chloride, magnesium chloride, calcium chloride, potassium acetate, potassium chloride, urea, calcium magnesium acetate, sodium formate, potassium formate, or combinations of these salts. The most commonly used solid deicing agent is sodium chloride, which is mined as rock salt, but can also include salts collected from brines such as sea water, underground saltwater sources, or salt water lakes.

The term “performance enhancer” as used herein is any compound that can be added to a deicing composition to provide additional benefits to the composition. Examples of performance enhancers can include but are not limited to corrosion inhibitors, radiation absorbers, or thickeners. Corrosion inhibitors can include but are not limited to triethanolamine, gluconate salts and phosphate salts, such as orthophosphates, polyphosphates, pyrophosphates, Diammonium phosphate, monosodium phosphate and organic phosphonates. Radiation absorbers can include dyes such as Naphthol Green B dye or Liquitint® Green HMC, available from Milliken Chemical, Spartanburg, S.C. Thickeners can include compounds such as those disclosed in U.S. Pat. No. 6,156,227.

The term “liquid bittern” as used herein is a product derived from sea salt production, and is the liquid remaining after the partial removal of sodium chloride from seawater. Liquid bittern normally contains water along with a high concentration of magnesium chloride and lower concentrations of other salts.

The term “pre-wetting agent” as used herein is an aqueous solution of a compound or a mixture of compounds, such as a liquid deicing agent and an additive, which can be added to a solid deicing agent.

The term “pre-wetted deicer” as used herein a solid deicing agent that is treated with a pre-wetting agent prior to application to a surface. A pre-wetted deicer is sometimes referred to as a treated salt in the industry.

The term “corrosion inhibitor” as used herein a compound that is added to or a part of a deicer composition to reduce the corrosion to metals, pavement, and other surfaces. Corrosion inhibitors are most often used in combination with chloride salts.

Deicer Composition

The deicer composition of the present invention comprises a mixture of a liquid deicing agent and an additive. In one embodiment, the additive is hydroxyethyl cellulose. In another embodiment, the deicer composition further comprises a solid deicing agent. In an alternative embodiment, the deicer composition can include performance enhancers such as corrosion inhibitors, radiation absorbers, or thickeners. In one embodiment, the concentration of the deicing salt of the liquid deicing agent is between 10% to 60% by weight in solution, and the concentration of the additive is between 0.1% to 5.0% by weight. In one embodiment, the deicer composition is used as a deicer or anti-icer that is applied directly to a surface.

Liquid Deicing Agents

The liquid deicing agent of the deicing composition is a substance having at least one component such as a deicing salt that, when combined with water or ice, forms a liquid that has a lower melting point than water. For example, sodium chloride can form a solution with water in which the freezing point is lower than 0 degrees Celsius. Other deicing salts can also be used to form the liquid deicing agent such as sodium chloride, magnesium chloride, calcium chloride, potassium chloride, urea, potassium acetate, calcium magnesium acetate, sodium formate, potassium formate, and other acetate salts, formate salts, or combinations thereof.

Liquid bittern can also be used as a liquid deicing agent. Liquid bittern is a product derived from sea salt production, and is the liquid remaining after partial removal of sodium chloride from seawater. Liquid bittern normally contains water along with a high concentration of magnesium chloride and lower concentrations of other salts. In one embodiment, the liquid bittern typically contains between about 20 and about 35 percent by weight magnesium chloride. Liquid bittern containing other concentrations, such as less than about 20 percent by weight magnesium chloride can also be used.

Additives

Suitable additives to be mixed with the liquid deicing agent to form the deicer composition include cellulose gum, polyvinyl pyrrolidone, acrylic acid polymers, cross linked acrylic polymers, polyether polyols, sodium carboxymethyl cellulose, hydroxyethyl cellulose, polyethylene oxide, polyethylene glycol, carboxymethyl hydroxypropyl guar, hydroxypropyl guar, polyanionic cellulose, pregelatinized crosslinked starch such as hydroxypropyl distarch phosphate and distarch phosphate, scleroglucan, pectin and combinations thereof. In one embodiment, the additive is hydroxyethyl cellulose. The additive can be in the amount of between 0.3% to 0.5% by weight to inhibit corrosion. In another embodiment, the concentration of the additive is between 0.2% to 0.8% by weight, or in another embodiment, between 0.1% to 5.0% by weight. The additive can be added to the liquid deicing agent as a direct dry additive.

In another embodiment, the deicer composition comprises a liquid deicing agent and hydroxyethyl cellulose. In one embodiment, the deicer composition contains between 0.3% to 0.5% by weight hydroxyethyl cellulose dispersed into an aqueous solution of between 10% to 60% by weight of a deicing salt. In another embodiment, the deicer composition contains between 0.3% to 0.5% by weight hydroxyethyl cellulose dispersed into an aqueous solution of between 25% to 33% by weight magnesium chloride. Other concentrations of hydroxyl ethyl cellulose can also be used, such as between 0.2% to 0.8% by weight, or between 0.1% to 5.0% by weight. The deicer composition can optionally include an additional corrosion inhibitor and a radiation absorber, such as a dye.

Solid Deicing Agents

Solid deicing agents can include chloride, acetate or formate salts, which can be mixed with water to form an aqueous solution referred to as a liquid deicing agent. Solid deicing agents can include sodium chloride, magnesium chloride, calcium chloride, potassium chloride, urea, potassium acetate, calcium magnesium acetate, sodium formate, potassium formate, or combinations of these salts. In one embodiment, the solid deicing agent is sodium chloride mixed with water to form the liquid deicing agent. In another embodiment, the deicing agent is magnesium chloride.

Performance Enhancers

The compositions discussed in the present disclosure can optionally include an additional corrosion inhibitor. In one embodiment, triethanolamine can be used as a corrosion inhibitor. Between 0.2% to 2.0% by weight triethanolamine is suitable for use as a corrosion inhibitor. Other suitable corrosion inhibitors can be used, including gluconate salts and phosphate salts, such as orthophosphates, polyphosphates, pyrophosphates, and organic phosphonates. Diammonium phosphate and monosodium phosphate are two phosphate salts that can be used individually or together to provide corrosion inhibition. Sodium gluconate is a gluconate salt that can be used individually or together with phosphates in the deicer composition to provide corrosion inhibition. Examples of other corrosion inhibitors include those disclosed in U.S. Pat. No. 6,156,227, which is co-owned with the present application and is incorporated herein by reference.

Suitable radiation absorbers can be used, including any agent capable of absorbing incident radiation and converting it to heat. Radiation absorbers include chemicals with a high molar absorptivity in the infra-red, visible and/or ultraviolet portions of the spectrum and exhibit high quantum yields for internal conversion, thereby efficiently converting absorbed solar radiation to heat. Compounds of this type include certain dyes. in one embodiment, Naphthol Green B dye can be used as a radiation absorber in accordance with the present disclosure. Between 0.05% to 0.5% by weight Naphthol green B dye is suitable for use as a radiation absorber.

Other combinations of ingredients for the deicer composition can be used in combination with the liquid deicing agent and additive to inhibit leaching. Examples of leaching inhibitors include those disclosed in U.S. Patent Application No. 2007000820216, which is co-owned with the present application and is incorporated herein by reference.

### EXAMPLES

Aspects of certain methods in accordance with aspects of the invention are illustrated in the following examples. In addition, tests have been developed to measure the effectiveness of this disclosure.

### Example 1

Corrosion tests were run according to the following procedure: the test coupons used are ASTM F 436, Type 1 flat steel washers with approximate dimensions 1.38 in. outer diameter, 0.56 in. inner diameter, and 0.11 in. thick with a density of approximately 7.85 grams per cubic centimeter and a Rockwell Hardness of C 38-45. Coupons are wiped with hexane to remove grease and oil and then acetone rinsed. The coupons are removed from the acetone, allowed to air dry and then weighed to the nearest 0.1 mg.

Approximately 360 grams of each liquid deicer is put into a 500 milliliter Erlenmeyer flask. Each flask is equipped with a rubber stopper that has been drilled to allow a line to run through it. Three coupons are mounted in a plastic holder that is suspended inside the flask through the stopper hole. A timed device raises and lowers the test coupons so that they are completely immersed in the test solutions for 10 minutes and then raised so they are suspended within the flask and above the test solution for 50 minutes. This cycle is repeated for 68-72 hours, depending on the test. Tests are conducted at room temperature. At the end of the exposure period the coupons are removed from the test solutions and scrubbed with a nylon brush under running water to remove coarse corrosion products. They are then immersed in a cleaning solution of approximately 3.8% hydrochloric acid and 0.1% Rodine 213 in warm tap water for approximately 20 minutes. The coupons are then removed, scrubbed again with a nylon brush under running water, immersed in an acetone bath and allowed to air dry. The coupons are then re-weighed to the nearest 0.1 mg. Fresh coupons that have not been exposed to the test solutions are also taken through the same cleaning procedure to determine the weight loss due to the cleaning process. The weight loss due to cleaning is subtracted from the total weight loss of the test coupons to determine the actual corrosion weight loss. A corrosion rate in mils per year is calculated from the measured coupon weight loss using the formula: mils per year=(weight loss of coupons in milligrams ×534)/(coupon area in square cm×test exposure time in hours×density of coupons).

TABLE 1
Corrosion Rates of Deicer Compositions on Mild Steel

| | Corrosion Rate |
|---|---|
| Deicer Composition | (mils per year) |
| 23.3% NaCl | 15.7 |
| 23.3% NaCl, 1.0% hydroxyethyl cellulose (Aqualon Natrosol Hi-Vis) | 3.4 |
| 23.3% NaCl, 0.60% polyanionic cellulose (Aqualon AquaFLO-HV) | 7.4 |
| 23.3% NaCl, 0.55% hydroxypropyl guar (Aqualon Galactasol 476) | 5.6 |
| 23.3% NaCl, 0.60% carboxymethyl hydroxypropyl guar (Aqualon Galactasol 650) | 5.8 |
| 23.3% NaCl, 0.70% cellulose gum (CPKelco Cekol 2000) | 7.3 |
| 23.3% NaCl, 0.65% hydroxyethyl cellulose (Aqualon Natrosol HI-VIS) | 4.8 |
| 23.3% NaCl, 2.5% pectin (Cargill Unipectine OF 400) | 1.5 |
| 23.3% NaCl, 3.1% pregelatinized, crosslinked starch (hydroxypropyl distarch phosphate) | 2.4 |
| (Cargill Polar-Tex 12640) | |
| 23.3% NaCl, 3.1% pregelatinized, crosslinked starch (distarch phosphate) (Cargill Stabi-Tex | 3.2 |
| 12620) | |

TABLE 2
Corrosion Rates of Deicer Compositions on Mild Steel

| | Corrosion Rate |
|---|---|
| Deicer Composition | (mils per year) |
| 23.3% NaCl | 15.3 |
| 23.3% NaCl, 5.0% Polyethyleneglycol (MW 20 kDa) | 12.1 |
| 23.3% NaCl, 5.0% Polyvinylpyrrolidone (MW 0.9-1.7 | 8.4 |
| MDa) | |
| 23.3% NaCl, 1.0% scleroglucan (Cargill Actigum CS 6) | 1.7 |

TABLE 3
Corrosion Rates of Deicer Compositions on Mild Steel

| | Corrosion Rate |
|---|---|
| Deicer Composition | (mils per year) |
| 23.3% NaCl | 14.1 |
| 23.3% NaCl, 2.5% Na Carboxymethylcellulose (MW~90 | 6.3 |
| kDa) | |
| 23.3% NaCl, 3.5% Na Carboxymethylcellulose (MW~90 | 4.8 |
| kDa) | |
| 23.3% NaCl, Na salt of polyacrylic acid (MW~8 kDa) | 11.4 |

The data in Table 1 show that addition of 1.0% hydroxyethyl cellulose causes a 78% reduction in the corrosiveness of sodium chlorideliquid deicing agent as compared to the use of sodium chloride brine alone.

All patents and publication referred to above are incorporated herein by reference. The particular embodiments disclosed above are illustrative only, as the present disclosure can be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above can be altered or modified and all such variations are considered within the scope and spirit of the present disclosure. Accordingly, the protection sought herein is as set forth in the claims below.

1. A deicer composition comprising:
a. A liquid deicing agent, wherein the liquid deicing agent comprises an aqueous solution of a deicing salt; and
b. An additive, wherein the additive is selected from the group consisting of cellulose gum, polyvinyl pyrrolidone, acrylic acid polymers, cross linked acrylic polymers, polyether polyols, sodium carboxymethyl cellulose, hydroxyethyl cellulose, polyethylene oxides, polyethylene glycol, carboxymethyl hydroxypropyl guar, hydroxypropryl guar, polyanionic cellulose, pregelatinized crosslinked starch such as hydroxypropyl distarch phosphate and distarch phosphate, scleroglucan, pectin and combinations thereof.

2. (canceled)

3. The composition of claim 1, wherein the deicing salt comprises a chloride, acetate, or formate salt such as sodium chloride, magnesium chloride, calcium chloride, potassium chloride, urea, potassium acetate, calcium magnesium acetate, sodium formate, potassium formate, or combinations thereof.

4. The composition of claim 1, wherein the liquid deicing agent is liquid bittern.

5. The composition of claim 1, wherein the deicing salt is present in a concentration of between 10% to 60% by weight in solution.

6. The composition of claim 1 wherein the additive is present in a concentration of between 0.1% to 5.0% by weight.

7. The composition of claim 1 wherein the additive is present in a concentration of between 0.2% to 0.8% by weight.

8. The composition of claim 1 wherein the additive is present in a concentration of between 0.3% to 0.5% by weight.

9. The composition of claim 1, further comprising a solid deicing agent.

10. The composition of claim 9, wherein the solid deicing agent comprises a sodium, acetate or formate salt such as sodium chloride, magnesium chloride, calcium chloride, potassium chloride, urea, potassium acetate, calcium magnesium acetate, sodium formate, potassium formate, or combinations thereof.

11. (canceled)

12. The composition of claim 10, wherein the additive is present in a concentration of between 0.001% to 1.0% by weight.

13. The composition of claim 10, wherein the additive is present in a concentration of between 0.01% to 0.5% by weight.

14. The composition of claim 9, further comprising a performance enhancer, wherein the performance enhancer is a corrosion inhibitor, a radiation absorber, a leaching inhibitor, or combinations thereof.

15. (canceled)

16. A deicer composition comprising:
a. A liquid deicing agent; and
b. Hydroxyethyl cellulose.

17. The composition of claim 16, wherein the liquid deicing agent comprises an aqueous solution of a deicing salt.

18. The composition of claim 17, wherein the deicing salt comprises a chloride, acetate, or formate salt such as sodium chloride, magnesium chloride, calcium chloride, potassium chloride, urea, potassium acetate, calcium magnesium acetate, sodium formate, potassium formate, or combinations thereof.

19. The composition of claim 17 wherein the liquid deicing agent is liquid bittern.

20. The composition of claim 17, wherein the deicing salt is present in a concentration of between 10% to 60% by weight.

21. The composition of claim 16 wherein the hydroxyethyl cellulose is present in a concentration of between 0.1% to 5.0% by weight.

22. The composition of claim 16 wherein the hydroxyethyl cellulose is present in a concentration of between 0.2% to 0.8% by weight.

23. The composition of claim 16 wherein the hydroxyethyl cellulose is present in a concentration of between 0.3% to 0.5% by weight.
